(19) United States
(12) Patent Application Publication
(10) Pub. No.: US 2011/0296465 A1
(43) Pub. Date: Dec. 1, 2011

(54) Making Televisions Connected and Collaborative

(75) Inventors: Balaji Sengodan Krishnan, Redwood City, CA (US); Ashish Kumar Bhardwaj, Menlo Park, CA (US); Rakesh Mathur, Saratoga, CA (US)

(73) Assignee: SNAPSTICK INC., Cupertino, CA (US)

(21) Appl. No.: 13/117,040

(22) Filed: May 26, 2011

Related U.S. Application Data
(60) Provisional application No. 61/379,067, filed on Sep. 1, 2010.
(60) Provisional application No. 61/349,773, filed on May 28, 2010.

(51) Int. Cl. H04N 5/445

(52) U.S. Cl. 725/51

(57) ABSTRACT

A television interface unit (TVIU) allows users to use a client device to select content from internet for watching on a television and to control the presentation of the content on the television. The TVIU sends web-pages from the internet to the client device. The user can select a web page comprising digital content received from the TVIU and indicate to the TVIU to present the same content on a television. The client device can be disconnected from the TVIU to perform other activities and subsequently reconnected to the TVIU to resume control of the content presented on the television. A TVIU can be controlled using multiple client devices and a single client device can control multiple TVIUs. The TVIU can be connected to other TVIUs to synchronize viewing of content on multiple televisions, thereby allowing social interaction based on internet content presented on a television.

### CROSS REFERENCES TO RELATED APPLICATIONS

This application claims a benefit of, and priority under, 35 U.S.C. §119(e) to co-pending U.S. Provisional Patent Application No. 61/379,067 entitled “Making Televisions Connected and Collaborative,” filed on Sep. 1, 2010, and to U.S. Provisional Patent Application No. 61/349,773 entitled “Making Televisions Connected and Collaborative,” filed on May 28, 2010, the contents of each being incorporated by reference herein in their entirety.

### BACKGROUND

This disclosure relates to playing internet content on conventional media players including televisions and music systems.

Users of conventional media players have a traditional style of interaction with the media players. For example, a television is traditionally used as media consumption device by users with a style that can be called a lean-back experience of watching a television. Typically, in a conventional “lean-back experience” a user flips channels on the television using a remote control while leaning back on a couch watching media from television channels being played. With the advent of more channels via cable and satellite, user interaction with the television has increased. For example, in a minimal fashion a user may browse a television guide and choose a channel using the television remote control device. The interaction of the user with the television essentially comprises actions to display a channel of choice to the user with the help of the remote control device. In contrast, typical users of internet consume internet media via a computer through a “lean-forward” experience i.e., a physically close interaction with a device. In a lean-forward experience, the user actively interacts with the devices to search/discover media or web pages to be consumed from the internet.

In addition, conventional approaches for consuming media and internet content makes it difficult to see arbitrary internet content on other devices, i.e., a physically farther removed interaction or a large viewing area interaction. Large viewing devices, e.g., televisions, are not suited for manipulation of web content for various reasons. For example, web content requires a rich set of controls that are typically not supported by conventional remote controls. Moreover, web content uses small fonts that are typically not suitable for a lean back user experience. Accordingly, conventional technology does not enrich the user experience in trying to watch some arbitrary web content, e.g., a HULU hosted program, on a larger viewing device.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

FIG. (“Figure”) 1(a) is a diagram of an embodiment of the functional set-up for connected televisions enabled by a television interface unit (TVIU).

FIG. 1(b) shows an embodiment of the system environment illustrating the interactions between the television, TVIU, and the internet enabled devices acting as remote controls.

FIG. 2(a) is a block diagram illustrating one embodiment of various components of a TVIU.

FIG. 2(b) illustrates the various layers of components in one embodiment of a TVIU shown as layers.

FIG. 3 is an interaction diagram illustrating the interactions according to an embodiment between a client device, a TVIU, and the television.

FIG. 4(a-e) illustrate one embodiment of the interactions between a client device acting as a remote control and a television controlled by the client device via TVIU.

FIG. 5 illustrates one embodiment of the one-to-many social interactions from a single moderator to a plurality of televisions using TVIU.

FIG. 6 illustrates one embodiment of the many-to-many social interactions between a plurality of moderators using TVIU.

FIG. 7 illustrates one embodiment of the many-to-one social interactions from a plurality of moderators to a single television using TVIU.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Example Configuration Overview

Embodiments disclosed include presentation of internet content on media players, such as televisions while retaining the types of interaction that the user has with the television. For example, the user behavior with television/web is retained and the fullest potential of the web is utilized for presentation on television. Embodiments disclosed present content obtained from the internet onto televisions. Furthermore, televisions are connected with the internet, thereby allowing social interactions between viewers of television.

Embodiments allow search of, and interaction with, arbitrary web content retrieved from a client device, e.g., a smartphone, and have it immediately sent to, i.e., “snapped,” for presentation onto a target device, e.g., a television or display. Further the configuration allows for the client device to retain control, if desired, over the content “snapped” to the target device.

Embodiments disclosed further allow one user to access multiple televisions from a single control device as well as allow multiple users to access one television from multiple control devices. As a result, users can share and interact through connected televisions, thus making television interaction social.

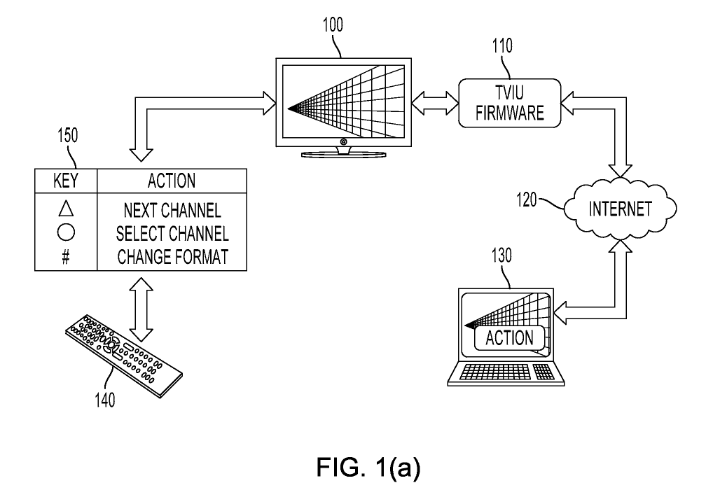

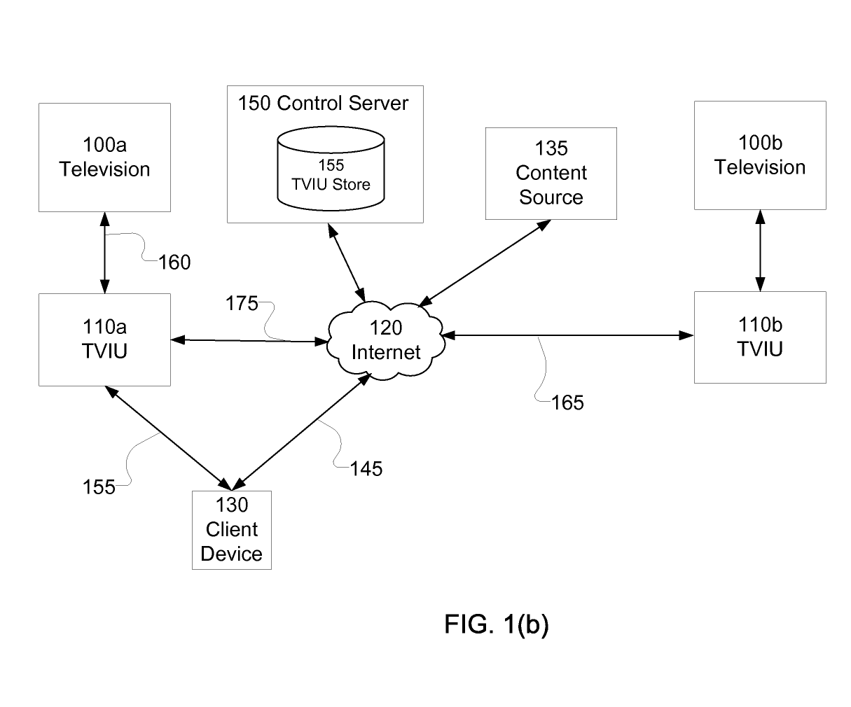

Referring to FIG. 1(a), it illustrates an embodiment of the functional set-up for connected televisions enabled by a television interface unit (TVIU). FIG. 1(a) shows a television 100, TVIU 110, the internet 120, a conventional television remote control, and the internet 120 enabled devices as remote controls 130 (e.g., a client device, a smartphone, or a tablet). The television 100 may receive signals from a conventional television remote control 140. The TVIU 110 has access to internet 120 through which content is presented on the television and functionality of the internet utilized. The internet content may be displayed in a browser that is integrated within the TVIU. The display is then streamed out to the television screen. The internet content is rendered on the television screen in the same way as it is rendered in a browser.

The television 100 is a device that receives and displays video and audio signals received through an over the air medium (e.g., broadcast antenna or satellite television) or wire (e.g., cable television). Typically, a television is associated with a remote control that allows a user to control the television. Typically television remote controls have the ability to translate some key combinations into actions on television. However, these mapping functions are predefined and difficult to reconfigure for a television remote control. Therefore, a television remote control works only if the number of actions to be performed is limited and if the actions are standard across content presented on the television. For example, changing channel, changing volume, pause, and turning power on/off are actions that are standard across all televisions and across all channels.

In contrast to conventional television configurations, content available on the internet can be provided by various sources and there is a wide variety of content in various formats with various different associated actions. In other words, the number of actions associated with content on the web is very high and the types of actions and user interfaces are not standard across web contents. For example, internet videos provide a slider to allow a user to input a position from which the content should be played. Similarly, web applications provide specialized buttons or key combinations to toggle between full-screen mode and a window mode that displays the content in a smaller window. Similarly, web applications support functionality including searching for content using search engines, commenting on content, viewing comments related to the content, indicating like/dislike for the content, changing resolution of the content, retrieving information from a uniform resource locator (URL) associated with the content, for example, a URL for an ad, and the like. Such functionality is typically not provided by a television remote control 140 and may not be possible, or may be extremely cumbersome, using the restricted set of keys on a television remote control 140. However, the disclosed embodiments enable users to watch internet content using a television and also provide all the functionality described above that is available to a user watching internet content via a computing device.

Helping to enable the disclosed configurations is the TVIU 110. The TVIU 110 is configured to allow users to view content from internet on a television. Moreover, the TVIU 110 enables a television to be socially connected to remotely located users. The TVIU 110 may be embodied in firmware. Alternatively, the TVIU 110 may be embodied in hardware in a field programmable gate array (FPGA), or application specific integrated circuits (ASIC). A TVIU comprises hardware, operating systems and applications (like browser, etc.). The component has functionalities and capabilities of a computing device and is optimized for managing interactions between connected televisions. The TVIU 110 can reside either inside the television or in an external form (e.g., USB stick, a set top box etc.,) that is connected to the television externally. The TVIU 110 is used as an enabler to make any television connected thereby exploiting functionality typically available on the internet via the television. In an embodiment, the TVIU may be embodied as a software module. In an embodiment, the software module can be downloaded on any computing device, for example, a laptop or a desktop and the computing device used as a TVIU. The computing device may be connected to the television using a standard interface cable.

### System Environment

Referring FIG. 1(b), it illustrates an embodiment of the system environment illustrating the interactions between the television 100, TVIU 110, and client device 130 acting as remote controls. FIG. 1(b) shows televisions 100a, 100b, a content source 135, TVIU 110a, 110b, internet 120, a control server 150, and a client device 130. The client device 130 can be any computing device including a handheld device, handheld computer, desktop computer, laptop, smartphone, mobile phone, tablet computer, netbook, or personal digital assistant (PDA). The client device 130 interacts with the television 100 via the TVIU 110. The client device 130 can search for content on the internet and retrieve content from content sources 135 via the internet. The TVIU 110 can also retrieve content from the content source 135 via the internet 120. A TVIU 110a may interact with another TVIU 110b via the internet 120.

The configuration illustrated in FIG. 1(b) allows for search of, and interaction with, arbitrary web content retrieved from a client device 130. The user can select any content and have it immediately sent to, i.e., “snapped,” for presentation onto a target device, e.g., a television or display. Further the configuration allows for the client device to retain control, if desired, over the content “snapped” to the target device.

By way of example, a user can use client device 130 to select arbitrary web content using tools available on a computing device such as a web browser and search engine. Once a selection of content is made on the client device 110 the user, through a single action “snaps” the selected content for playback onto a target device, e.g., a television. To effect this interaction, the TVIU 110 acts as an interface between the client device 110 and television 100. The snap single action causes information describing the content presented on the client device 130 to be transmitted to the TVIU 110. The content presented on the client device 130 can be described using a URL of the webpage presented on the client device 130 along with any other information required to access the URL, for example, user name and password. Other information describing the content includes information describing the web session including the user's preferences so that the user's preferences are preserved when the content is presented on the television. Additional information describing the content may include a position of a frame of the video presented on the client device, for example, if the video has been forwarded or viewed up to that frame.

In an embodiment, the control server 150 stores information describing multiple TVIUs 110 in a TVIU store 155. Information stored in the TVIU store 155 includes network information describing how a client device 130 can access a TVIU 110. In this embodiment, the “snap” single action causes information describing the content presented on the client device 130 to be sent by the client device 130 to the control server 150. The client device 130 can reach the control server 150 via the internet 120. The client device 130 obtains information describing a particular TVIU 110 so as to establish a direct connection with the TVIU unit, for example, a per-to-peer connection. The peer-to-peer connection may be established using a UDP (user datagram protocol) hole punching technique. If the control server 150 determines that a router used for the communication does not support UDP hole punching techniques, the control server 150 may use a cloud based relay server to relay information between the TVIU 110 and the client device 130. This operation is slow compared to a direct communication between the client device 130 and the TVIU 110. If the control server 150 determines that the client device 130 falls in the same network as the TVIU 110, the control server 150 sends the appropriate information to the client device 130 to allow it to access the TVIU 110 using an internal internet protocol (IP) address.

Once a direct connection is established between a client device 130 and a TVIU 110, the two devices can communicate directly without sending information via the control server 150. For example, any control signals for changing the presentation of the content can be directly sent by the client device 130 to the TVIU 110. In an embodiment, a standard communication protocol or a proprietary communication protocol can be used for communication between the client device 130 and the TVIU 110. In some embodiments, the communication protocol is layered on top of a hypertext transfer protocol (HTTP) so that a standard web server running on a TVIU 110 can be used to format, decode, and receive communication packets based on the communication protocol. In an embodiment, the control server 150 periodically sends a signal (called a “heartbeat” signal) to TVIUs 110 associated with the control server 150. The heartbeat signal determines the latest information describing each TVIU 110, for example, any changes in the network access information for a TVIU.

By way of example, the client device 130 can be used to retrieve 145 content from any content source 135 at a location within the internet 120, e.g., World Wide Web. The client device 130 and the TVIU 110 and the content source 135 may interact via any network, for example, a local area network. A user can select arbitrary content from the internet 120 by using tools available to the client device 130 such as a search engine and a web browser.

In the example illustrated through FIG. 1(b), a user performs a single action 155 that “snaps” selected web content viewed on the client device 130 to a first television 100a via a first TVIU 110a. The single-action of a snap now presents the selected content, which was initially seen on the client device 130, onto the first television 100a. More particularly, the first TVIU 110a retrieves the desired content, identified through the client device 130, from the network 150 and provides it for display on the first television 100a. Substantially simultaneously, the first TVIU 110a presents the retrieved content to the client device 130. The first TVIU 110a can provide the same content to the client device 130 or alternately can optimize communications with the client device 130 by sending a subset of information in the form of controls that are relevant to controlling the presentation of the content. The client device 130 interacts with controls on the retrieved content and the actions taken on the controls are sent through the first TVIU 110a to be effected on the content playing in the first television 100a.

The user can disconnect the client device 130 from the first TVIU 110a to perform other activities and the first TVIU 110a will continue to stream 165 the selected web content to the first television 100a. The client device 130 subsequently can be reconnected 155 with the first TVIU 110a to regain control of the content playing on the first television 100a.

The client device 130 can be configured to control multiple target devices, e.g., the first television 100a and a second television 100b. Similarly, multiple client devices can control the single target device, e.g., the second television 100b. The client device 130 interacts with the second TVIU 110b via the network 120. Accordingly, the client device 130, the second TVIU 110b and the second television 100b can be physically remote relative to each other.

In addition, a first TVIU 110a also can be synchronized with a second TVIU 110b, thereby allowing the client device 130 to simultaneously control the same web content presented on different target devices, e.g., televisions 100a and 100b. This allows the synchronized TVIUs to provide social interaction between different users associated with different target devices.

### TVIU Architecture

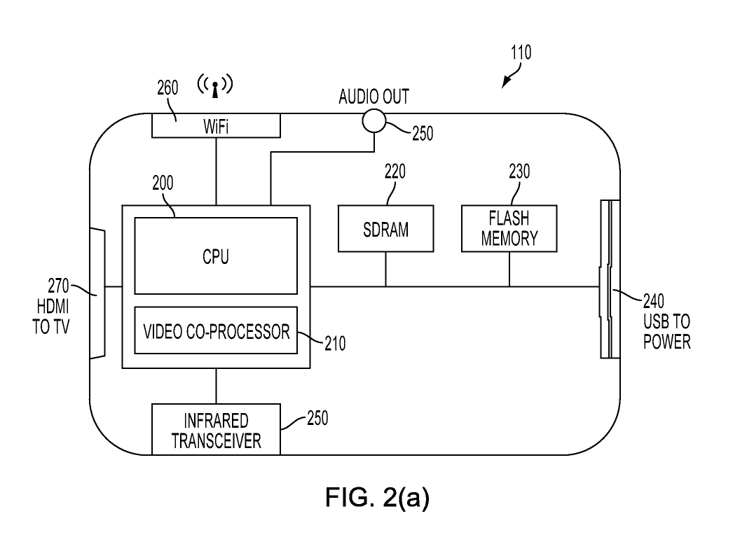

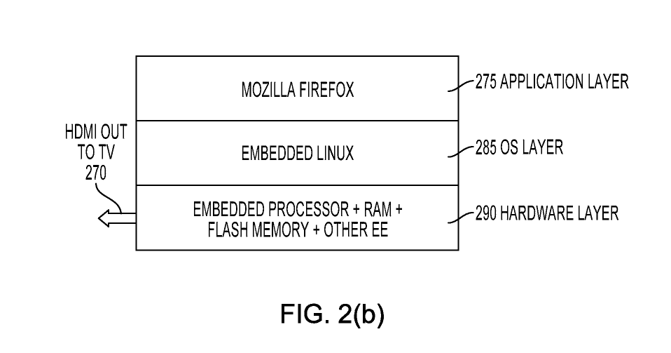

Turning now to FIG. 2(a), it illustrates example components of a TVIU according to an embodiment. In one embodiment, the TVIU 110 has a central processing unit (CPU) 200, a video co-processor 210, an infrared receiver 250, a synchronous dynamic random access memory (SDRAM) 220, a flash memory 230, a WI-FI transmitter 260, an audio out port 250, an HDMI to television port 270, and a USB port for receiving power 240. The CPU 200 and video co-processor 210 receive control signals from the infrared transceiver 250 and can send signals to port 270 and 250. The CPU 200 and video-coprocessor can store information in the SDRAM 220 and flash memory 230. The port 240 is connected to a power supply. Other embodiments can have multiple CPUs 200 and co-processors 210 according to the needs. In an embodiment, the co-processor 210 is used as a multi-format video encoder and a graphic accelerator used to enhance the video encoding-decoding and for rendering graphics for display on the screen. The co-processor 210 enhances the quality of videos and graphics obtained from the internet and displayed on the television 100. In one embodiment, the CPU 200 is used as the main computing component. The hardware component of TVIU has a WI-FI 260 component (and/or an Ethernet port 3G or 4G, LTE (long term evolution) or other communication module) that is used to connect to the internet in order to access the web content. The hardware component of TVIU may have an audio output 250 that can be directly connected to any audio device like speakers etc., so that the device has capabilities of streaming just the audio from the web to the connected devices. In one embodiment, the hardware component of TVIU has SDRAM 220 for memory requirements and Flash memory 230 for storage.

The hardware component of TVIU may have an infrared (IR) transceiver 250 that can receive infrared signals from different sources (like a remote control) and perform actions accordingly. On the other hand, the IR transceiver 260 is also capable of transmitting infrared signals to other devices that can receive IR signals. In one embodiment, the IR transceiver 260 in the hardware component of TVIU can be used for two different purposes: (1) A user can program the TVIU 210 to map 150 a conventional remote control 140 keys to predefined actions as shown in FIG. 1; (2) A user can use TVIU 110 (by sending signals over internet or IR or other means) to control other devices like set-top boxes or televisions or any IR enabled devices. The hardware component of TVIU may have a power input 240 either through an USB port or a dedicated power socket or it can also carry a battery (or like power source) as a source of power for the TVIU.

Referring to FIG. 2(b), it illustrates the various layers of components in one embodiment of a TVIU 110 shown as example component layers. For example, the TVIU 110 comprises a hardware layer 290, an operating system (OS) layer 285, and an application layer 275. The hardware layer 290 executes the operating system 285 and the application layer 275 executes applications using the operating system 285. The various parts of the hardware layer 290 are illustrated in detail in FIG. 2(a). The operating system layer 285 in an embodiment may comprise an embedded operating system, for example, embedded LINUX. The application layer 275 provides the various applications that are used for retrieving content from the internet and for managing the presentation of the content, for example a browser application such as MOZILLA FIREFOX, MICROSOFT INTERNET EXPLORER, APPLE SAFARI, or GOOGLE CHROME.

Embodiments of the disclosed configuration allow users to use any of their personal computing devices that are internet enabled to browse the web. A user can select a particular media content for presentation on the television via a single-action comprising a selection of a user interface components, for example, a single click of a button or a URL or a single motion selection and drag to effect an action (a “snap single-action”.). Browsing using the personal computing devices is typically performed by users, as described below.

Continuing with respect to describing an example operation, in a first phase, a website is provided for users for purposes of registering their TVIU 110 and also for performing any required configuration of the TVIU 110. Users use a client application such as a browser using their client device 130 to access the website for registration and configuration of their TVIU 110. The user provides the TVIU's unique id and a password to the website to allow the user to register and configure the TVIU 110. Alternatively, a plug-in (or a client software module) may be provided to the browser on the user's client device 130 to allow the client device 130 to communicate to the TVIU 110. The plug-in allows the client device 130 to access the TVIU 110 without having to go to configuration website to gain access to the TVIU 110. Once the credentials are validated, the users gain access to the TVIU 110 within the browser or using an application software program. This allows users to see the display of the browser that is integrated within TVIU 110 inside the local browser in their client device 130. This can be considered a presentation of a browser within a browser.

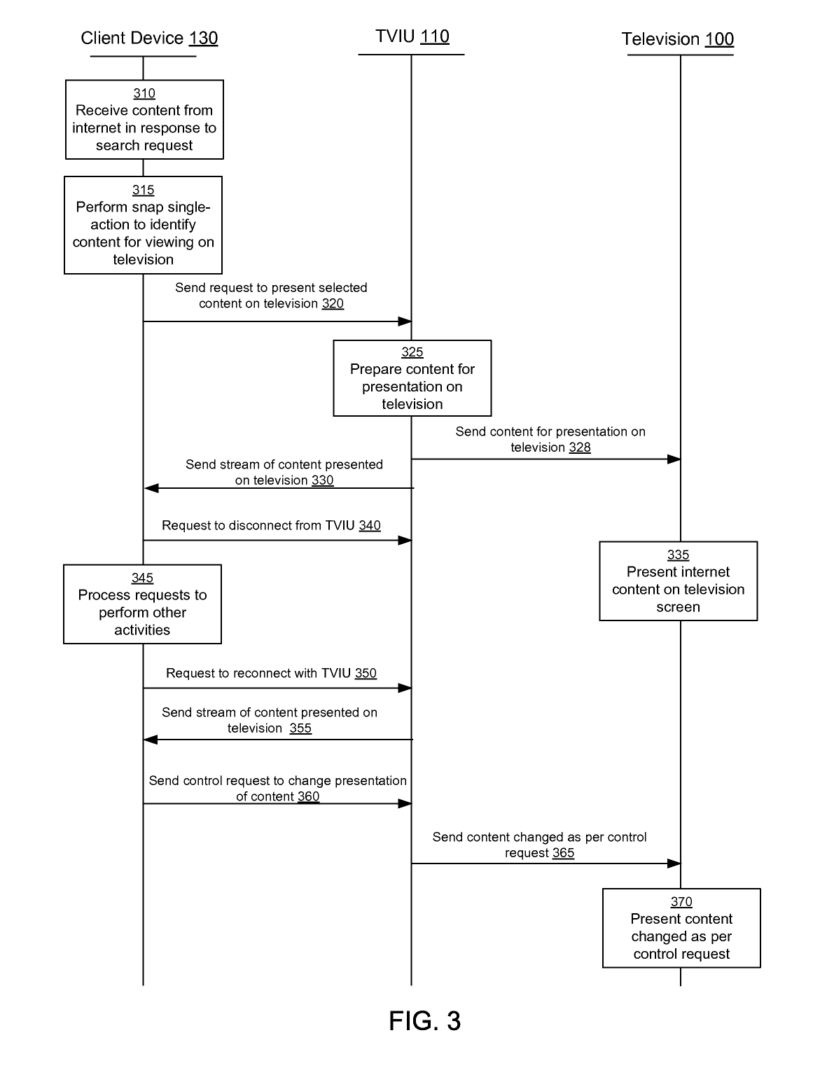

Referring to FIG. 3, it illustrates the interactions between the client device 130, the TVIU 110, and the television 100 according to an embodiment. The user uses the client device 130 to browse content from the internet. The user may perform searches using search engines and receive 310 content in response to search requests. The user identifies 315 a particular content for viewing on the television 100, for example, a particular video. The user may even forward through portions of the video and identify a particular frame of the video from where to start viewing the video on the television 100.

In an embodiment, the TVIU 110 can present information presented on the browser running on the TVIU within the browser of the client device 130. The user can browse content from the internet 120 within the display rendered from the TVIU 110 locally on the client device 130. Embodiments perform optimizations so that the browsing mostly happens using the computing power of the client device 130 (that is used to connect to TVIU) instead of always using the computing power of the TVIU 110. In other embodiments, the browsing is performed entirely using the browser of the client device 130. The user can use the browser of the TVIU 110 to perform searches on the internet 120 or perform any actions required to select content for viewing on the television 100. Once the user has selected the desired content to be displayed on television 100, the user performs 315 a snap single-action to send 320 a request to the TVIU 110, to present the identified content on the television screen. In an embodiment, the snap single-action is performed by clicking on a component of the user interface, for example, a button or a uniform resource locator (URL) link. The TVIU 110 prepares 325 the content for presentation on the television. The TVIU 110 sends 328 the content for presentation to the television 100. In an embodiment, the TVIU natively renders the video and streams it to the television, for example, via high-definition multimedia interface (HDMI.) These steps allow the user to identify the content to be presented on a television in a lean-forward way using the client device 130.

Once the internet content is displayed on television, the user can stay connected to the TVIU 110 to control the displayed content. The TVIU sends 330 a stream of the content presented on the television 100 back to the client device 130. For example, if a video obtained from the internet 120 is played on television 100 from TVIU 110, the same video is sent by the TVIU 110 to the client device 130 for presentation on the client device 130. As a result, the display on the television is mirrored on the client device 130 connected to the TVIU 110. In an embodiment, the client device 130 uses a pull model for retrieving frames of the video from the TVIU 110. The client device 130 can adjust the rate at which it retrieves the frames of the video from the TVIU 110. In another embodiment, the TVIU 110 uses a push model to send the frames of the video to the client device 130. In this embodiment, the TVIU 110 adjusts the resolution and frame rate for the video based on information describing the client device, for example, the type of display of the client device 130 and the computing power of the client device 130. For example, the resolution of a television screen may be 1920×1680 pixels. However the stream of video sent to a smartphone, e.g., an IPHONE need not have the information required for the resolution for a large screen television screen.

The TVIU reduces the resolution of the stream sent to the client device 130 appropriately based on the type of display screen available at the device. Similarly, if the number of frames per second sent to an IPHONE is comparable to the number of frames per second used for a television, the IPHONE may get overloaded by performing computation intensive processing of the frames. Therefore, the TVIU reduces the number of frames per second to a rate determined based on the computation power available at the client device. Some optimizations may be performed by the client device 130 based on context information available to the client device 130. For example, if a user is zooming into a frame of the video, the client device 130 may either reduce the number of frames retrieved during this time interval or even stop retrieving frames while the zooming operation is performed. As another example, the TVIU 110 may adapt the format of the data stream sent to the client device 130 based on a type of hardware accelerator determined to be available on the client device 130. Depending on a type of hardware accelerator available on the client device 130, the TVIU 130 may send an encoded stream of images in a given format, e.g., a moving picture experts group (MPEG) format, a sequence of raw images, or the video in any other format.

In an embodiment, the stream of video sent by the TVIU to the client device 130 sends information describing pixels, for example, the color and depths of the pixels. The number of pixels per frame that are sent by the TVIU depend on the resolution of the screen of the client device 130. The information describing the pixels allows the client device 130 to display the information that is displayed by the TVIU 110 on the television screen. The TVIU 110 performs optimizations to allow the client device 130 to present the required information efficiently. In an embodiment, only the information describing pixels that changed compared to a previous frame is sent to the client device 110.

Streaming the content displayed on the television 100 on the client device 130 via the TVIU 110 allows the user to send control signals related to the video to the TVIU 110. The TVIU 110 receives the control signals from the client device 130 and changes the presentation of the video on the television 100 based on the control signals. For example, the user may pause a video, play the video that is paused, fast forward the video, use a slider to advance to a particular position in the video, and the like. An equivalent action is processed by the TVIU 110 so as to cause an appropriate change to the presentation of the video on the television 100. As a result, the user is able to use the client device 130 to pause or play or perform any such actions for controlling the presentation of the content on the television 100. For example, a swipe action on a smartphone, e.g., IPHONE may be converted to a fast-forward operation in the TVIU 110 and the video accordingly displayed as being fast-forwarded in the television.

Once the content selected by the user from the internet 120 is displayed on television 100, the user can send a request 340 to disconnect the client device 130 from the TVIU 110. When user disconnects from the TVIU 110, the TVIU 110 may stop sending the stream of content back to the client device 130. The user can start watching the web content on television 100 in a “lean-back” way, which is the usual behavior of users watching televisions. On the other hand, the client device 130 (that was previously connected to the TVIU 110 and acted as a remote control) is freed up to process 345 requests for other regular activities that a user would perform using the client device 130. As a result, the client device 130 acts as a multi-tasking remote control for the television 100. The web content that was displayed on television 100 continues to play on the television 100 since the presentation of the content on the television is controlled by the TVIU 110.

The user can disconnect the client device 130 from the browser on TVIU 110 and reconnect at any stage to provide further control actions for the video being watched on the television 100. For example, the user can watch a portion of the video on the television 100 while the client device 130 is disconnected from the TVIU 110 and then send 350 a request reconnect the client device 130 to the TVIU 110. The TVIU 110 may stream 355 the content presented on the television 100 via a webpage to the client device 130. The user may send (or transmit) 360 via the client device 130, a control request to change the presentation of the content on the television 100, for example, to skip certain portion of the video. The control request is sent 365 by the client device 130 to the TVIU 110. The TVIU 100 effects the control to the television 100 to present 370 the content as per the control request. The user may subsequently, disconnect the client device 130 again and continue watching the remaining portion of the video on the television.

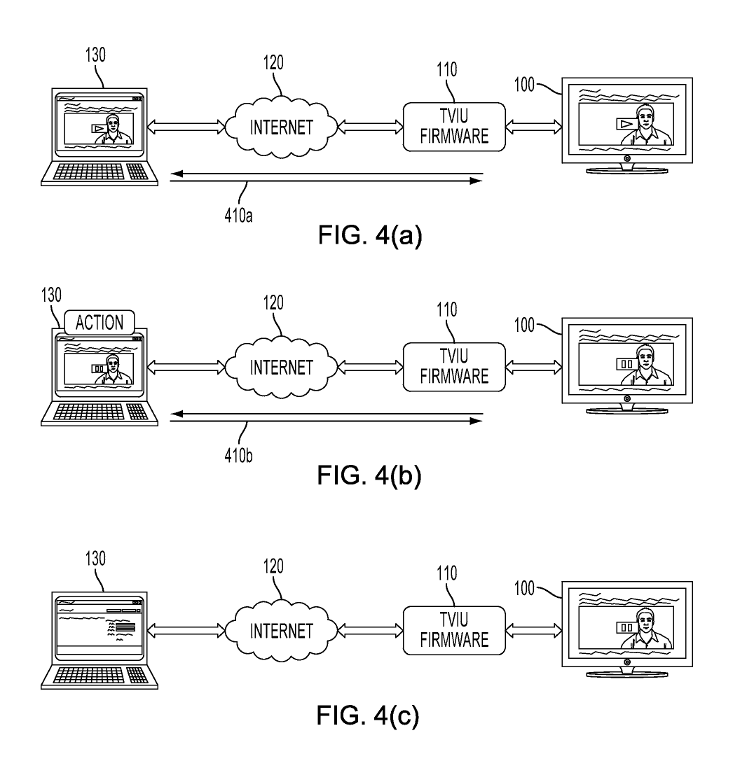

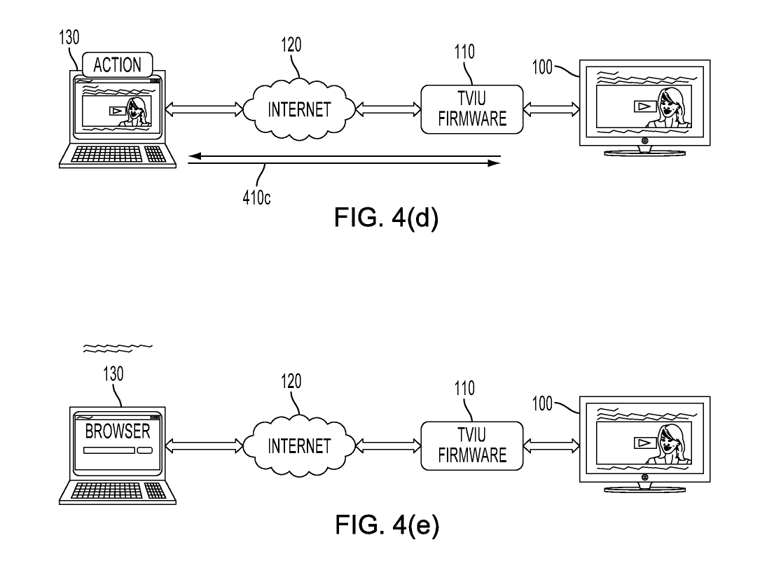

Turning next to FIGS. 4(a-e), they illustrate an embodiment of the various interactions between a device acting as a remote control and a television controlled by the device via TVIU. FIG. 4(a) shows the client device 130 being connected 410a via the internet 120 to the TVIU 110 and used to send a control signal to the video on the television 100. FIG. 4(b) shows the client device 130 still connected 410b via the internet 120 to the TVIU 110 and used to send a different control signal to the video on the television 100. However, FIG. 4(c) shows the client device 130 disconnected from the TVIU 110. Accordingly, the client device 130 in FIG. 4(c) is being used for purposes other than controlling the video being played on the television 100. FIG. 4(d) shows the client device 130 reconnected 410c to the TVIU 110 for sending another control signal to the television 100. FIG. 4(e) shows the client device 130 yet again disconnected from the TVIU 110 while the television 100 is playing the video. The client device 130 as shown in FIG. 4(e) is being used for performing activities different from controlling the television 100. Accordingly, the client device 130 can be connected or disconnected from the TVIU 110 depending on whether the user needs to control the content presented on the television 100 or to perform unrelated activities using the client device 130.

The ability to use the client device 130 to control the television provides control mechanisms available on the internet that are not provided by conventional television remote controls 140. Examples of control mechanism that can be used by a user to control a television 100 using a client device 130 via a TVIU 110 include use of a slider that a user can drag via a cursor to a desired position on a scale. Also, a user can toggle the mode in which the web content is viewed on a television 100 between a full-screen mode and a mode that displays the content in a smaller window. The user can provide comments on the content, or indicate like/dislike of the content, and view comments provided by other users for the content, if these functionalities are supported by the website providing the content. Furthermore, the user is provided with access to search tools that can be used to search for internet content and view the content on the television screen. The user can also interact with other users via the client device used as a controller, for example, via a social networking system or any other messaging system to obtain content recommended by other users which can then be viewed on the television screen. Alternatively, the user can communicate with other users, for example, friends of the user in the social networking system to recommend the content watched by the user.

The client device 130 used as a remote control for controlling display on a television 100 via a TVIU 110 may be a device with limited resources, for example, a smartphone with limited display area and limited processing power and memory. The TVIU 110 allows for optimizing the use of resources by providing different modes in which the client device is operated, each mode sending a subset of information required to be presented in the client device 130. The information displayed on the client device 130 comprises the controls of the video being displayed, the actual video being displayed, and other browser functionality including search or other applications used for finding/surfing content to be presented.

In one mode, the user can operate the client device 130 with the full functionality of the browser necessary to allow for searching or surfing the internet in order to select particular content for presentation. For example, the user may interface with a social networking application to interact with other users to find a video recommended by the user's friends.

In another mode, the client device 130 displays only the video (or content) being presented and the controls for manipulating the content. For example, after finding a video to view on the internet 120, a user may want to quickly preview the video on the client device 130 before viewing the full video on the television. In the quick preview, the user may wish to forward to specific portions of the video or view specific scenes.

Another mode allows the user to only view the controls of the content on the client device 130 while viewing the actual video on the television 100. This is the mode in which the user is likely to spend significant portion of the time watching the video. In this mode, the TVIU 110 renders on the client device 130 only the portion of the screen necessary for controlling the video/content. This reduces the amount of information being sent by the TVIU 110 to the client device 130 acting as a remote control. Furthermore, this maximizes the information of interest (the video/content) being displayed by the television screen without cluttering the television screen with control information. Embodiments provide user interface to switch between the various modes described above.

A webpage can be a mix of HTML content (usually represented as document object model or DOM) and content presented by media players, for example, ADOBE FLASH, MICROSOFT SILVERLIGHT, or APPLE QUICKTIME. The HTML DOM contents are rendered by the browsers whereas third party media players like Flash Players render the content that is played using the third party media players, for example, ADOBE FLASH, MICROSOFT SILVERLIGHT, or APPLE QUICKTIME. Browsers typically do not have any control on the content played using the third party media players. In an embodiment, the content rendered by third party media players is sent from the TVIU 110 to the client device 130 (acting as controller) display as they cannot be controlled by the local browsers in the client device 130. The other DOM components can be locally rendered by the browser in the client device (using the computing resources of the client device).

In an embodiment, the TVIU 110 stores logic and information describing various third party media players available to an internet viewer. The information comprises portions of the media player display that correspond to the control and the portions that correspond to the content that is presented. This information is used by the TVIU 110 to separate the control portion of the rendered screen for the media player from the content portion. The control portion of the rendered screen is sent to the client device 130 acting as the remote control and the content portion is sent to the television screen. The information is stored as metadata for various the media players. When the user uses a particular media player to view the content, the appropriate media player description is retrieved and used by the TVIU 110 to optimize the information rendered on the client device and the television screen.

In another embodiment, the client device 130 does not access the TVIU 110 resources and utilizes only the resources of the client device 130 when the user is searching for content to view. Once the user finds a video to view on the television, the client device uses the resources of the TVIU 110 to render and provide a remote display of components like third party media players.

In an embodiment, the user can switch the content viewed on the television between internet content and the content from the cable channels. In order to achieve a seamless experience between cable and internet, TVIU 110 comprises an IR transceiver that is built into it. The IR transceiver is required to convert a TVIU 110 as a remote control for other devices like set-top boxes and televisions. One will control the TVIU 110 using a client device 130 and the control is internally translated to the appropriate infrared transceiver signal that is issued to change channels (for example) both in the set-top box and on the television (to change the high-definition multimedia interface (HDMI) source for example). The IR transceiver 250 on the TVIU 110 is programmed to send signals that a regular television remote control used to control set-top boxes and televisions. The TVIU 110 issues appropriate infrared signals based on the commands issued by the client device 130n acting as a controller. For example, if a user gets a recommendation of a movie that is available on channel-512 on cable, and if the user clicks on that recommendation, the TVIU 110 seamlessly takes the user to channel-512 by flipping to the right HDMI source on television (where the set top box is connected). On the other hand, if the user clicks on one of the recommendations of online contents, the TVIU 110 again automatically changes the HDMI source where the TVIU 110 is connected.

In an embodiment, the same TVIU 110 can be connected to multiple televisions to control the content presented on all the televisions connected to it. The TVIU unit can be configured to present the same content on all the televisions connected to it. The TVIU 110 unit can also be configured to connect to one television at a time in order to control the content of that particular television. Accordingly, the TVIU can be used to allow a user to control multiple televisions and still view different content on each television.

In other embodiments, TVIUS can be synchronized with each other to coordinate content presented on televisions connected to the respective TVIUs. For example, two TVIUs can interact with each other, each TVIU connected to a Television. These two TVIUs can communicate with each other and synchronize their contents by passing metadata between the TVIUs. Each TVIU can retrieve its content from the internet and the synchronization may not require streaming content from one TVIU to another. Thus a first TVIU can send metadata to the second TVIU informing it of the content displayed by the first TVIU. The second TVIU can use the metadata to retrieve the appropriate content from the internet. The control signals between the two TVIU units can be synchronized. For example, a user can fast forward content displayed on a first television via the first TVIU and the control signals transmitted to the second TVIU to fast forward content displayed on a second television controlled by the second TVIU. As a result, people living in a house can synchronize content viewed in two different rooms with two different televisions connected to two different TVIUs. The televisions and TVIUs can be located remotely, for example, in two different cities or even two different countries. Only one of the users needs to perform the internet search or other interactions to find appropriate content to watch. The other users can synchronize the signals of their TVIU units to watch the same content without having to use the browser to retrieve the content.

### Social Television

The web allows social interaction between people including friends and families. For example, it allows people to share information like their favorite movies, what they like, where they are etc. These interactions may be performed using social networks. The disclosed embodiments further enhance conventional social networks by enabling sharing of content on a television even when members of a particular social network are spread over widely diverse geographical areas and/or time zones. Moreover, the disclosed configurations enable such sharing of television content in real time and “on the fly.” For example, users can watch movies from the internet on a television such that the content they watch is synchronized with same content watched by their friends on another television even when those friends may be living in a remote location, for example, a different city, in a different time zone. Further, the synchronized nature of the configuration allows for a watching experience as though the two or more parties are in the same physical location watching the same television. For example, a replay of a sports highlight controlled by a first television 100a with a first TVIU 110a is watched by other televisions that are geographically dispersed but communicatively coupled through their own TVIU with the first TVIU so that all these other television sets are watching the exact same controlled replay simultaneously with the first television 100a.

Embodiments allow users to access remote TVIUs from a client device 130 in the same way they access their own TVIU connected to their television. The control of the remote TVIUs may be performed via a local TVIU. For example, a client device 130 may send a control signal to a local TVIU, e.g., a first TVIU 110a, that broadcasts the control signal to one or more remote TVIUs. This allows users to retrieve content from internet and reflect the same content in multiple TVIUs at the same time. In this case, the content does not get streamed from one TVIU to another, but each TVIU uses its own computing resources to retrieve the content from the internet. However, all TVIUs communicate and exchange information so that they can present the same content at the same time. Any action that is performed in one of the TVIUs is communicated to other TVIUs in a group so that the same action is reflected in all of TVIUs at the same time. For example, a user can form a group that comprises of TVIU T1 and TVIU T2. The user can access T1 and perform an action, say play a web video. This action is communicated automatically to T2 by T1 so that T2 will also retrieve the same web video directly from the internet. This allows users of T1 and T2 to watch the same web video at the same time sitting in two different places. One of the two users can invite a third TVIU to join the group or the third TVIU can request to join the group.

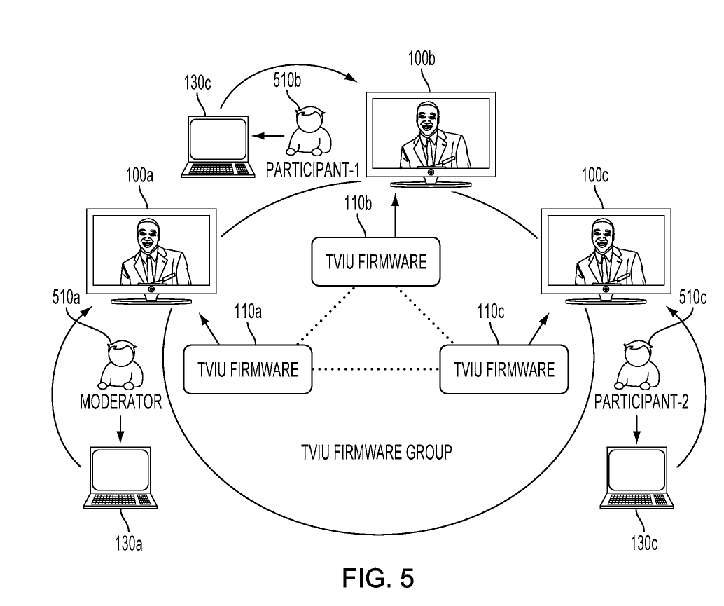

Referring to FIG. 5, it illustrates one example embodiment of the one-to-many social interactions from a single moderator to a plurality of televisions using TVIU. FIG. 5 shows interactions between multiple users 510 controlling televisions 100 using client devices 130 via the TVIU 110. As shown in FIG. 5, the user 510a controls the television 100a via the TVIU 110a using the client device 130a. Similarly the user 510b controls the television 100b via the TVIU 110b using the client device 130b and the user 510c controls the television 100c via the TVIU 110c using the client device 130c. The user 510a acts as a moderator and the users 510b and 510c act as participants in a social interaction involving the content viewed via their respective televisions 100. The user 510a also plays the role of a participant since the user 510a watches the video 100a as the other participants watch their respective videos.

The user 510a sends a control signal to the TVIU 110 using the client device 130a. The control signal sent by the user 510a controls the television 100a that the user 510a can watch. However, the control signal is also sent by the TVIU 110a to the TVIU 110b and TVIU 110c. The TVIU units 110b and 110c are acting in a slave configuration whereas the TVIU 110a is acting in a master configuration. The TVIU units 110b and 110c execute the control signals received from the TVIU 110a and control their respective televisions 100b and 100c accordingly. As a result the control signals sent to all three televisions 100a, 100b, and 100c are configured to perform the same action or sequence of actions.

This allows the user 510a acting as a moderator to control the presentation of the video on multiple televisions that may be situated remotely, for example, in a different city or even a different country. For example, a user located in United States who finds some interesting news videos can interact with the user's friends in another country, for example, China to show them the news videos. The remote participants do not have to independently search the internet for the videos in order to watch them. The moderator user 510a can also skip to interesting portions of a video by forwarding through the uninteresting portions and the participants (510b and 510c) enjoy the benefits of the moderator's efforts without putting in similar efforts. The moderator user 510a can show a portion of a video, stop that video and show a portion of another video to all the participants (510b and 510c).

In an embodiment, a website is provided to the users 510a, 510b, and 510c to setup the connections between their TVIU 110 units in a particular configuration describing the different roles as moderators or participants. The roles of the various users can also be changed. For example, in a subsequent social interaction, the user 510c can act as the moderator while the users 510a and 510b act as the participants.

The second scenario allows multiple users to access the same TVIU 110 and the control capabilities can be defined by the TVIU owner. The same TVIU 110 can be accessed from different computing devices because the access is primarily through a browser. This scenario helps when multiple people want to perform different actions either sitting in the same place or at different places. Multiple remote controls for controlling the same television avoid resource contention caused by a single remote control.

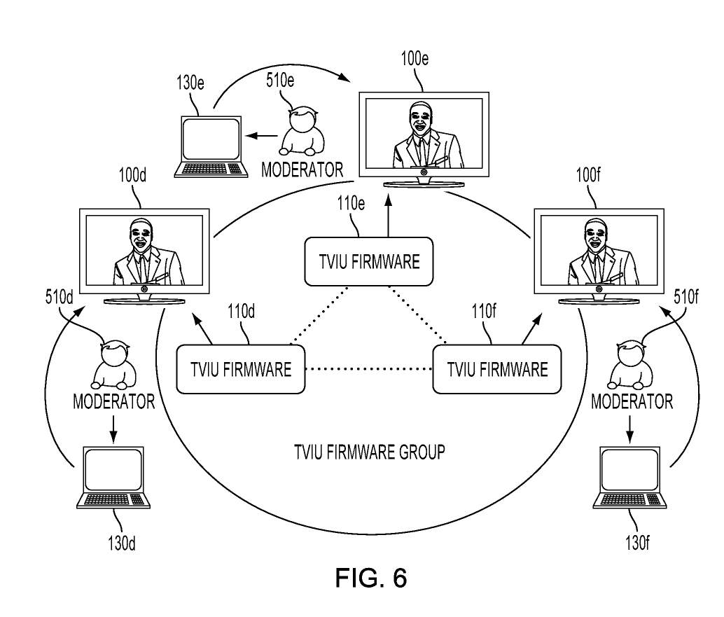

Referring to FIG. 6, it illustrates an embodiment of many-to-many social interactions between a plurality of moderators using TVIU 110. As shown in FIG. 6, the user 510d controls the television 100d via the TVIU 110d using the client device 130d. Similarly the user 510b controls the television 100b via the TVIU 110b using the client device 130b and the user 510c controls the television 100c via the TVIU 110c using the client device 130c. Each user is configured to act as a moderator and can therefore control the display of the other users participating in the interaction. In an embodiment, a TVIU 110 is assigned a primary owner. The TVIU 110 may also be assigned multiple secondary owners. The different owners may be associated with different security access levels. The security levels of the secondary owners may be assigned by the primary owners. The control server 150 stores the details of various owners assigned to each TVIU 110. The actions available to each owner associated with a TVIU 110 are determined by the security access level associated with the owner.

The users can interact with their existing social networks to share what they are watching, their thoughts on different shows etc that are played on television while watching those media on television. This is done using their personal computing devices even when they are disconnected from the TVIU 110. Once the user logs in to the TVIU 110, then the browser in the client device 130 (or client software) stores and remembers details about the user and the associated TVIU 110 so that when the user shares his thoughts on the social networks (by providing some feedback), his feedback automatically is associated with the content that is currently played on television from the associated TVIU 110.

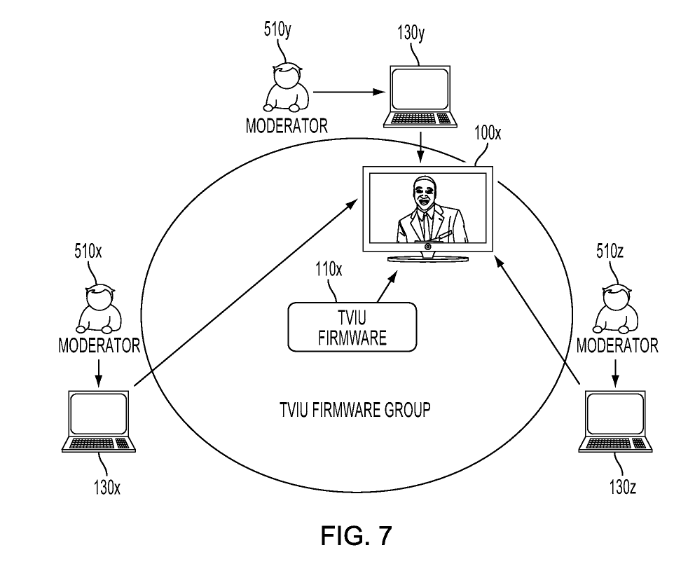

FIG. 7 illustrates one example embodiment of many-to-one social interactions from a plurality of moderators to a single television 100 using TVIU 110. As shown in FIG. 7, the user 510x, 510y, and 510z all can control the television 100x via the TVIU 100x using their respective client devices 130x, 130y, and 130z. Each user 510 shown in FIG. 7 can act as a moderator and control the videos presented on the television 100x. The moderator users 510x, 510y, and 510z may be residents of the same household that control the television 100x at different times. The moderator users 510x, 510y, and 510z can also make a series of presentation involving videos a set of audience watching the television 100x. The moderator users 510x, 510y, and 510z can also control the videos presented on the television 100x remotely.

In an embodiment, an access control mechanism is centrally managed in a server that stores a mapping from each user to a TVIU or multiple TVIU units. Similarly, multiple users can be mapped to the same TVIU. If the user wants to access a TVIU that he/she does not own, the request is sent to the owner of the TVIU and if permission granted, the TVIU can be accessed by the user. In an embodiment, the TVIU 110 includes software modules that exchange credential information with the centralized server based on which the access mechanism is controlled.

To sum, embodiments presented allow a user to view and manipulate internet content on television. Examples of the configurations presented and their benefits include but are not limited to the following. The user can select any content available on the web for presentation on the target device. The control mechanisms available for arbitrary content on web (such as full-screen, pause, play, close window, open new links, search, etc . . . ) can be executed by the user via the client device 130 to control the presentation of that content on the target device. This provides the flexibility and richness of the user interfaces of content available on the internet, but for controlling the presentation of the content on the target device, e.g., a television.

Multiple TVIUs can interact with each other. For example, this allows social interaction between users that involves presentation of content on televisions watched by the users. For example, a user can control content presented on a television being watched by him, and synchronize the control signals with content being presented on the televisions of several of his friends, each friend watching his/her own television in a different city.

The client device 130, the TVIU, and the target device can be configured to interact via the cloud. Accordingly, there is no requirement of physical proximity between the three devices interacting with each other. For example, a smartphone can be used to control a television being watched in a different country.

The user can disconnect the client device 130 from the target device and use the client device 130 to perform other activities, for example, for sending emails, browsing the web, etc. At any stage the client device 130 can resume control of the content being presented on the target device.

Multiple devices can control the presentation of content on the same target device, e.g., a television. For example, a first client device, e.g., a smartphone, can be used to pause the content presented on the television. At a later stage a second client device, e.g., a tablet computer, can be used to resume the presentation on the same television or perform any other control of the presentation. Similarly, one client device can be used to control the presentation of content on multiple target devices, e.g., a television and a desktop computer.

### Alternative Applications

The foregoing description of the embodiments has been presented for the purpose of illustration; it is not intended to be exhaustive or limited to the precise forms disclosed. Persons skilled in the relevant art can appreciate that many modifications and variations are possible in light of the above disclosure.

Some portions of this description describe the embodiments in terms of algorithms and symbolic representations of operations on information, for example, in FIGS. 4(a-e) and 5-8. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments is intended to be illustrative, but not limiting, of the scope of the invention, which is set forth in the following claims.

What is claimed is:

1. A computer implemented method of presenting media content obtained from internet onto a television, the method comprising:
receiving a web page having a video from internet, the web page including a user interface for controlling presentation of a video;
transmitting information describing the user interface comprising the video for presentation on a client device;
transmitting information describing the video for presentation on a television;
receiving a control input from the client device for causing a change in the presentation of the video; and
transmitting information describing the video for presentation on the television such that the presentation is changed as specified by the control input.

2. The computer implemented method of claim 1, further comprising:
receiving commands to select media content from the internet by obtaining one or more web pages from the internet.

3. The computer implemented method of claim 1, further comprising:
receiving commands to perform a search on the internet, wherein the search is for content on the internet.

4. The computer implemented method of claim 1, wherein the control input comprises an action specified by dragging a slider on a scale to control the current position of the video presented.

5. The computer implemented method of claim 1, wherein the control input comprises displaying a video in a full screen mode.

6. The computer implemented method of claim 1, wherein the control input comprises at least one of playing a video, pausing a video, stopping a video that is playing, forwarding a video, or reversing a video.

7. The computer implemented method of claim 1, wherein the television is a first television, the web page is a first web page, the video is a first video, the user interface is a first user interface, the control input is a first control input, the configuration is a first configuration, the method further comprising:
receiving a second web page having from internet including a second user interface to control presentation of a second video;
transmitting information describing the second user interface to the client device;
transmitting information describing the second video for presentation on a second television;
receiving a second control input from the client device configured to cause a second change in the presentation of the second video; and
transmitting information describing the second video for presentation on the second television such that the presentation is changed as specified by the second control input.

8. The computer implemented method of claim 1, further comprising:
receiving a request for presenting information describing content associated with one or more television channels;
transmitting information describing the content associated with the one or more television channels to the client device;
receiving a selection of content associated with the one or more television channels;
transmitting the selection of content associated with the one or more television channels for presentation on the television.

9. The computer implemented method of claim 1, wherein the control input is a first control input, the configuration is a first configuration, the change to the configuration is a first change to the configuration, and the client device is a first client device, the method further comprising:
transmitting information describing the user interface to control the presentation of the video to a second client device;
receiving a second control input from the second client device for causing a second change in the presentation of the video;
transmitting information describing the video for presentation on the television such that the presentation is changed as specified by the second control input.

10. The computer implemented method of claim 1, wherein receiving a web page, sending information describing the user interface, sending information describing the video, receiving a control input, and sending an instruction are performed by a first television interface unit (TVIU), and the television is a first television, the method further comprising:
transmitting by the first TVIU, the instruction to a second TVIU for changing the presentation of the video on a second television associated with the second TVIU.

11. A computer implemented system for presenting media content obtained from internet onto a television, the system comprising:
a computer processor; and
a computer-readable storage medium storing computer program modules configured to execute on the computer processor, the computer program modules comprising:
an application configured to:
receive a web page from internet, the web page comprising a user interface for controlling presentation of a video;
transmit information describing the user interface for presentation on a client device;
transmit information describing the video for presentation on a television;
receive a control input from the client device to cause a change in the presentation of the video; and
transmit information describing the video for presentation on the television such that the presentation is changed as specified by the control input.

12. The computer implemented system of claim 11, wherein the television is a first television, the web page is a first web page, the video is a first video, the user interface is a first user interface, the control input is a first control input, the configuration is a first configuration, the application further configured to:
receive a second web page from internet comprising a second user interface to control presentation of a second video;
transmit information describing the second user interface to the client device;
transmit the information describing the second video for presentation to a second television;
receive a second control input from the client device configured to cause a second change in the presentation of the second video; and
transmitting information describing the video for presentation on the television such that the presentation is changed as specified by the second control input.

13. The computer implemented system of claim 11, wherein the application is further configured to:
receive a request for presenting information describing content associated with one or more television channels;
transmit information describing the content associated with the one or more television channels to the client device;
receive a selection of content associated with the one or more television channels;
transmit the selection of content associated with the one or more television channels for presentation on the television.

14. The computer implemented system of claim 11, wherein the control input is a first control input, the configuration is a first configuration, the change to the configuration is a first change to the configuration, the instruction is a first instruction, and the client device is a first client device, the application further configured to:
transmit information describing the user interface to control the presentation of the video to a second client device;
receive a second control input from the second client device for causing a second change in the presentation of the video;
transmitting information describing the video for presentation on the television such that the presentation is changed as specified by the second control input.

15. The computer implemented system of claim 11, wherein receiving a web page, sending information describing the user interface, sending information describing the video, receiving a control input, and sending an instruction are performed by a first television interface unit (TVIU), and the television is a first television, the application further configured to:
transmit the instruction to a second TVIU for changing the presentation of the video on a second television associated with the second TVIU.

16. A computer program product having a computer-readable storage medium storing computer-executable code for presenting media content obtained from internet on a television, the code comprising an application configured to:
receive a web page having a video from internet, the web page including a user interface for controlling presentation of a video;
transmit information describing the user interface for presentation on a client device;
transmit information describing the video for presentation on a television;
receive a control input from the client device for causing a change in the presentation of the video; and
transmitting information describing the video for presentation on the television such that the presentation is changed as specified by the control input.

17. The computer program product of claim 16, wherein the television is a first television, the web page is a first web page, the video is a first video, the user interface is a first user interface, the control input is a first control input, the configuration is a first configuration, the application further configured to:
receive a second web page having a video from internet including a second user interface to control presentation of a second video;
transmit information describing the second user interface to the client device;
transmit the information describing the second video for presentation to a second television;
receive a second control input from the client device configured to cause a second change in the presentation of the second video; and
transmit information describing the video for presentation on the television such that the presentation is changed as specified by the second control input.

18. The computer program product of claim 16, wherein the application is further configured to:
receive a request for presenting information describing content associated with one or more television channels;
transmit information describing the content associated with the one or more television channels to the client device;
receive a selection of content associated with the one or more television channels;
transmit the selection of content associated with the one or more television channels for presentation on the television.

19. The computer program product of claim 16, wherein the control input is a first control input, the configuration is a first configuration, the change to the configuration is a first change to the configuration, the instruction is a first instruction, and the client device is a first client device, the application further configured to:
transmit information describing the user interface to control the presentation of the video to a second client device;
receive a second control input from the second client device for causing a second change in the presentation of the video;
transmit information describing the video for presentation on the television such that the presentation is changed as specified by the second control input.

20. The computer program product of claim 16, wherein receiving a web page, sending information describing the user interface, sending information describing the video, receiving a control input, and sending an instruction are performed by a first television interface unit (TVIU), and the television is a first television, the application further configured to:
transmit the instruction to a second TVIU for changing the presentation of the video on a second television associated with the second TVIU.
